(19) United States
(12) Patent Application Publication
(10) Pub. No.: US 2002/0052814 A1
(43) Pub. Date: May 2, 2002

(54) Virtual real estate brokage system

(76) Inventor: Robert M. Ketterer, Villanova, PA (US)

Correspondence Address: Douglas Wm. Massinger, Esquire, MASSINGER LAW OFFICE, 113 North Olive Street, Media, PA, 19063, US

(21) Appl. No.: 09/901,795

(22) Filed: Jul. 10, 2001

Related U.S. Application Data
(60) Provisional application No. 60/217,097, filed on Jul. 10, 2000.

(51) Int. Cl. G06F 17/60

(52) U.S. Cl. 705/35

(57) ABSTRACT

An electronic, virtual real estate brokerage system and method for guiding buyers and sellers of real estate through the process of a real estate transaction including listing of the property, searching of listed properties, scheduling of property showings, evaluation of buyer credit worthiness, negotiating the terms of sale, and providing all documents for closing, all over a communications and knowledge management network, preferably the internet. The system provides a forum for obtaining complementary services such as financing, title searches, title insurance and the like. The system provides two sets of user interfaces to accomplish all of the aforementioned functions; one set of interfaces for the sellers and one set for the prospective buyers of real estate.

### CROSS REFERENCE TO RELATED APPLICATION

This application claims the benefit of U.S. Provisional Patent Application number 60/217,097 filed on Jul. 10, 2000.

### FIELD OF THE INVENTION

The subject invention relates generally to a method and apparatus for guiding buyers and sellers of real estate through the entire process of real estate marketing, negotiation, purchasing, closing and post-closing activities. In particular, it relates to a system and method of brokering the sale of said real estate over an electronic network based on, inter alia, the sales criteria of the seller, purchase criteria of the buyer, and financial qualification of the buyer. As such, the subject invention is a virtual, electronic broker of real estate providing nearly all services currently provided by classical real estate brokers.

### BACKGROUND OF THE INVENTION

The prior art of real estate marketing and sales has evolved, of necessity, as a manual process which is facilitated by human brokers who have developed, and are members of, a large network of brokers. Such traditional means of carrying out real estate transactions are replete with inefficiency and other shortcomings and limitations which are perpetuated, in part, by the consumer's perception that real estate marketing and sales cannot be handled without an agent or broker to manage the complex, labor intensive process. This sometimes exaggerated perception of complexity and intensity is further reinforced by the fact that real estate sales are governed by the unique state specific laws corresponding to the property location. Further, the sheer magnitude of the financial implications to participants of a real estate transaction cause many participants to believe that formal representation is the only way to obtain a fair deal in the transaction. Finally, the former state of technology under which the current system of real estate brokerages developed did not allow for establishment of an effective, efficient alternative means for sellers and prospective buyers of real estate to find one another and to execute the process of real estate brokerage.

To appreciate the advantages of the subject invention over the prior art, it is helpful to first understand the functions performed by human real estate brokers and how they are compensated. Table 1, below, provides an overview of functions performed by a broker as well as those capable of being provided by the buyer and/or seller and by information technology made available through the subject invention.

TABLE 1
Real Estate Brokerage Functions

| Functions Currently | | |
|---|---|---|
| Performed by Real | Information Technology | Seller and/or Buyer |
| Estate Brokers | Capabilities | Capabilities |
| Post real estate and | ✓ | ✓ |
| seller attributes | | |
| Post electronic | ✓ | ✓ |
| images/video of real | | |
| estate | | |
| Provide means of | ✓ | ✓ |
| payment information | | |
| Provide showing dates & | ✓ | ✓ |
| times | | |
| Register real estate | ✓ | ✓ |
| Search for real estate | ✓ | ✓ |
| Evaluate real estate | ✓ | ✓ |
| candidate(s) within | | |
| parameters of search | | |
| criteria | | |
| Select real estate | | ✓ |
| candidate(s) | | |
| Select showing date & | ✓ | ✓ |
| time | | |
| Produce Credit Report | ✓ | |
| Transmit proposed | ✓ | |
| showing date & time & | | |
| credit report to seller | | |
| Evaluate buyer | ✓ | ✓ |
| candidate(s) | | |
| Select buyer candidate(s) | | ✓ |
| Confirm/decline showing | ✓ | ✓ |
| date(s) & time(s) | | |
| Show real estate | | ✓ |
| Negotiate | | ✓ |
| Agree on terms of sale | | ✓ |
| Obtain financing | ✓ | ✓ |
| Produce required | ✓ | ✓ |
| documentation to comply | | |
| with state law | | |
| Close transaction | | ✓ |
| Search for relevant | ✓ | ✓ |
| goods and services | | |

First, broker services are generally priced at 6% of the sale price of the home. Therefore, performance of these functions is jointly valued by both the seller and buyer of the real estate at approximately 6% of the home's sale price. Both seller and buyer value these services jointly because although the seller usually “pays” for the services of the real estate broker, in actuality the cost is shared by both the seller and the buyer. To illustrate, the seller of real estate is concerned only with the net proceeds from the sale of the home. If the seller is seeking $100,000 net proceeds from the sale, the seller adds the cost of real estate brokerage services to the desired net proceeds, resulting in an asking price of $106,000 (exclusive of all other costs). Through the negotiation process, the seller and buyer usually agree to a sale price that is between the asking price and the desired net proceeds for the home. The real estate brokerage fee is therefore a shared/joint cost of the seller and buyer. Through the application of current technologies and internet marketing potential, the brokerage cost to both the buyer and seller of real estate can approach, if not equal, zero.

Second, the current real estate broker network method of marketing is sub-optimal for the efficient and effective matching of sellers and buyers of real estate. By their very design, exclusive real estate listing arrangements severely limit exposure of the universe of properties to prospective buyers and provide nearly unlimited fee protection to the listing broker during the listing period. It is a standard practice for listing brokers to show only those homes for which the brokerage has an exclusive listing arrangement, referring prospective buyers to other brokerages only as a last resort for a reduced fee. Therefore, prospective buyers may not be exposed to homes of potential interest unless dealing with all real estate agents with listings in the locality of interest.

Third, since the listing brokerage is protected against the loss of the sales fee under an exclusive listing arrangement, there is very little incentive for the brokerage to sell the home in a timely fashion other than the desire for near term revenues. Near term revenues may not be a compelling incentive for brokerages, especially when selling homes of low to medium market value.

It is evident then that such practices limit market exposure to prospective buyers and sellers of real estate. Therefore, the potential exists to create a direct buyer-seller network which is more efficient and effective than the current manual brokerage methods.

Finally, given former limits of information management, real estate marketing practices have of necessity evolved under the presumption that prospective buyers know where they want to live. Therefore, location is currently assumed to be a primary criterion for search and selection of a home. Because of this assumption, prospective buyers are forced to select a specific locality, usually no larger than the smallest U.S. state, to conduct their home search. This significantly limits buyers' capabilities to search for homes based on primary criteria other than location. There are indeed segments of the real estate buyer market that are primarily interested in criteria other than location. As an example, retirees may be interested in searching for a 2,000 square foot home with a swimming pool and Florida room for no more than $200,000, regardless of where the property is located.

Clearly, there is a need for an alternative to the existing traditional real estate brokerage system. The subject invention obviates many if not all of the above described shortcomings and limitations of the prior art as will become evident upon review of the following summary and detailed description of the invention.

### SUMMARY OF THE INVENTION

The subject self-service real estate brokerage system is an internet-served application that creates a self-service, on-line direct brokerage capability for both sellers and buyers of real estate. Its design is based on the fact that a majority of the functions and real value provided by real estate brokers can be replicated by current information and knowledge management technologies in combination with the personal interaction and shared effort of the sellers and buyers of real estate. The invention acts as a virtual real estate broker, guiding the participants through the entire process of listing and searching for real estate, qualifying the buyer, negotiating, documenting and closing the sale.

Because of this virtual brokerage feature, the subject invention eliminates the perceived and real reasons given for the current practice of using human real estate brokers to facilitate these transactions. Further the subject invention provides both the seller and buyer with quick and easy access to complementary goods and services such as title insurance, legal information, and home inspection. The result then, is a greatly simplified, facilitated process that can easily be executed by the seller and buyer. Further, the system provides the seller and buyer with data regarding the subject real estate market so that both seller and buyer can be informed about the recent sales prices of similar real estate in the subject market. Further, the system provides guidance on negotiation techniques for both seller and buyer, further simplifying the brokerage process. Finally, the current and future states of technology do indeed allow for end-to-end execution of the real estate marketing and sales process.

According to one aspect of the invention, a host system and a plurality of remote data terminals exchange data through the Internet.

According to another aspect of the invention, a seller of real estate is able to produce a real estate record in the system database, which is housed by a centrally located computer server, via a remote data terminal and transmission means to the system database server provided by the internet.

According to another aspect of the invention, a prospective buyer of real estate is able to conduct a search, via a personal computer, of various home attributes listed in the real estate record that resides in the centrally located system and to produce a list of properties meeting the search criteria via the internet.

Further, the prospective buyer is able to schedule via a personal computer a showing time for any of the properties meeting the search criteria and to provide an electronic order and authorization to various credit agencies' computers to produce a credit report to be transmitted to the personal computer of the seller of subject real estate via the internet.

According to another aspect of the invention, via the sellers personal computer, the seller of subject real estate is able to access and review said prospective buyer credit reports sent electronically from various credit agencies via the internet and to accept or decline the scheduled showing time proposed by the prospective buyer or to propose an alternative showing time via the internet.

According to another aspect of the invention, the seller and buyer are able to access all forms and documentation for legal sale of real estate in the state in which the property exists from their respective personal computers via the internet. Further, the forms and documentation are accompanied by detailed instructions on proper completion of the forms and documentation.

According to another aspect of the invention, the seller and prospective buyer are able to access various knowledge resources to enable them to effectively negotiate the terms of sale of the subject property from their respective personal computers via the internet. These resources include, but are not limited to guidance on effective negotiation techniques, relevant information about the subject real estate market, and real estate buyer and seller checklists.

According to another aspect of the invention, the seller and buyer are able to access various services which are complementary to the marketing and sale of real estate from their respective personal computers via the internet. These services include, but are not limited to title insurance, title searches, legal representation, moving services, and mortgage lending. These services can be accessed via the invention through direct electronic links (portals) to the service providers' internet web pages.

According to another aspect of the invention, the system allows for the host to verify the sale and ownership of subject real estate by federal and/or state real estate registrars via the internet. According to this aspect of the invention, the system host will periodically monitor publicly posted real estate sale and ownership information through queries against federal, state and/or local real estate registrar web pages or publicly accessible databases.

According to another aspect of the invention, the system allows for the seller and prospective buyer of real estate to research real estate market conditions of subject real estate by federal, state and/or local real estate registrars or private real estate statistical services from their respective personal computers via the internet. According to this aspect of the invention, the seller and prospective buyer will be able to access publicly posted real estate sale and ownership information through queries against federal, state and/or local real estate registrar web pages or publicly accessible databases, and private real estate statistical service provider web pages.

According to another aspect of the invention, the system allows for the collection of fees from the seller of subject real estate via credit card payment over the internet.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide an electronic, virtual real estate broker metaphor which guides the participants through the entire process of real estate marketing and sales to include listing, searching, scheduling, evaluation of credit worthiness, negotiating, closing, documenting and obtaining complementary services.

It is another object of the invention to provide a self-service real estate brokerage application that guides participants through the entire real estate marketing and sales process over a data terminal, such as a personal computer.

It is another object of the subject self-service real estate brokerage system to provide services which are complementary to the sale of real estate.

It is also an object of the subject self-service real estate brokerage system to provide all required documentation customized for each specific transaction and compliant with the laws of the state in which the real estate exists.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a flow chart illustrating the major, high level activities enabled by the subject self-service real estate brokerage system;

FIGS. 2-4 are flow charts illustrating the processes of FIG. 1 in greater detail; and

FIG. 5 is a diagram of the technological architecture of the subject invention.

### DETAILED DESCRIPTION OF THE PREFERRED EMBODIMENT

The subject self-service real estate brokerage system includes a functionally and technically robust web application that walks the seller and prospective buyers of residential and commercial real estate through a simple exchange process. The process is facilitated by interactive dialogs using a virtual real estate broker metaphor. The virtual broker takes the participants through the process in interviews designed to collect required and other relevant data to match sellers' real estate listings with prospective buyers' selection criteria; and to provide relevant information and guidance regarding the sale of real estate to the users during the exchange process. Each of these activities will be facilitated through dialogues presented to the seller and prospective buyer by the virtual broker.

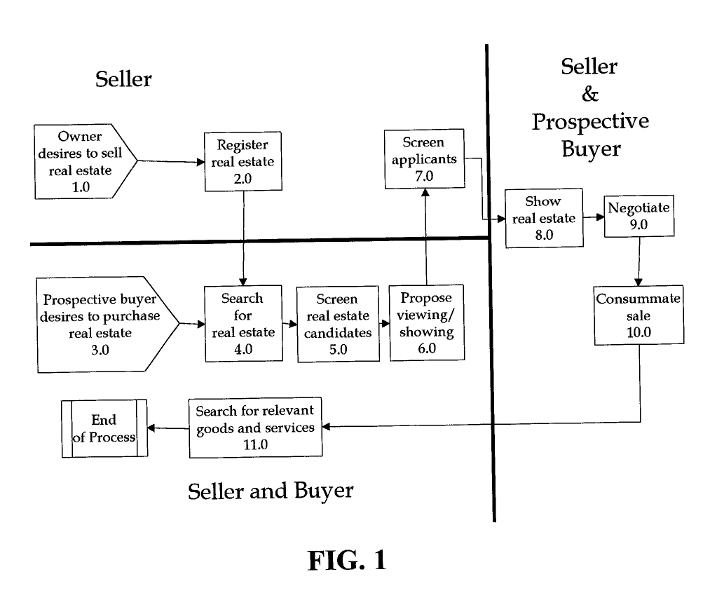

Reference now being made to FIG. 1, a flow chart of the major, high level activities enabled by the subject invention are illustrated. The process begins when an owner or owners of real estate desire to sell a property. Given this desire, the system allows the owner or owners to access the system application from the owner's personal computer via the internet in order to register the property for sale and to provide a means of payment therefore should said real estate be sold via the system. For simplicity's sake, the subject self-service real estate brokerage system, both as an apparatus and as a business method, will be referred to by the acronym, “SSREB”.

The SSREB process continues as prospective buyers desire to purchase real estate. The SSREB invention allows said prospective buyers to access the SSREB application from the prospective buyer's personal computer via the internet and to search for and obtain matches to properties listed on the SSREB which meet certain desired characteristics of listed properties which are input into the SSREB by the prospective buyers.

The SSREB application allows the prospective buyer to view and evaluate properties which match the desired characteristics by presenting electronic images of the properties and displaying the values of the selected search criteria and all other values associated with the properties.

The SSREB application allows the prospective buyer to select and schedule a property(ies) for showing and to provide the prospective buyers' social security number for electronic transmittal to a credit agency(ies) for production and electronic transmittal of a credit report to the seller of the subject property via the internet.

The system electronically transmits the proposed showing time for the subject property and the credit report(s) of the prospective buyer(s) of the property to the seller. The SSREB allows the seller to access and view the said showing time and credit report(s) and to either accept, decline or reschedule said showing time via the seller's personal computer and the internet.

Should the seller elect to accept the scheduled showing time proposed by the prospective buyer, or reschedule the showing time, the SSREB electronically transmits the confirmed showing time or the rescheduled showing time (as applicable) to the prospective buyer. The SSREB enables the prospective buyer to access this information from the prospective buyers personal computer via the internet.

After the seller and prospective buyer have completed the showing of the subject property (which is a manual process not enabled by the SSREB), the SSREB application enables the seller and prospective buyer to better negotiate the terms of sale of the subject property through provision of seller and buyer guidelines for sale and purchase of real estate. The SSREB application provides said guidelines on demand at any point in the SSREB process. This information is available from both the seller's and prospective buyer's personal computers in the form of files residing in the SSREB database or as portals to the web pages of providers of said information.

Further the SSREB application allows the prospective buyer to apply for and receive financing for the purchase of the subject real estate from the prospective buyer's personal computer via the internet through either direct linkage to one or more on-line home mortgage lenders or as an integral component of the SSREB application. Further, the SSREB application database receives the lending determination of the mortgage lender and all required documentation to verify said lending determination via automated electronic link from the mortgage lenders for whom the mortgage lenders services are an integral component of the SSREB application. The SSREB electronically transmits said lending determination and documentation to the prospective buyer and the seller of subject real estate via electronic mail messages to each, and to the record of the subject property in the SSREB database.

Further, the SSREB application enables the seller and buyer to produce the required documentation for the legal sale of the subject property in the state in which the property exists. The SSREB application enables this through electronic provision of the required forms for legal sale of real estate and detailed instructions for proper completion of said forms. The SSREB provides said forms and instructions on demand to both the seller and the prospective buyer at any point in the SSREB process.

Subsequent to the sale closing (which is a manual process not enabled by the SSREB), the SSREB application enables the seller to post the closing date, sale price and buyer name to the subject real estate record in the SSREB database from the seller's personal computer via the internet. Based on this information, the SSREB application automatically removes the subject real estate record from the active list of real estate for sale.

Further, if the closing date, sale price and buyer name of subject real estate are not provided to the SSREB after the fifth day after the scheduled closing date, the SSREB application automatically prompts the seller via electronic mail message to update the record with the actual (or rescheduled) closing date or to reactivate the real estate for sale.

Further, the SSREB application enables the seller to reactivate subject real estate record from the seller's personal computer via the internet.

Further, in case of re-activation of the subject real estate record by the seller, or no response from the seller within 21 days of the scheduled closing date, the SSREB application will automatically link to the relevant state and/or federal real estate registrar database(s) to verify the subject real estate has not been sold. If the subject real estate had been sold within the previous six months, the SSREB application automatically posts notification of sale, sale price and name of buyer to the subject real estate record within the SSREB database.

Further, the SSREB application provides for charging the credit card account of the seller of the subject real estate via the internet when sale of the subject property is verified by the seller or by the relevant state and/or federal real estate database(s) as previously described.

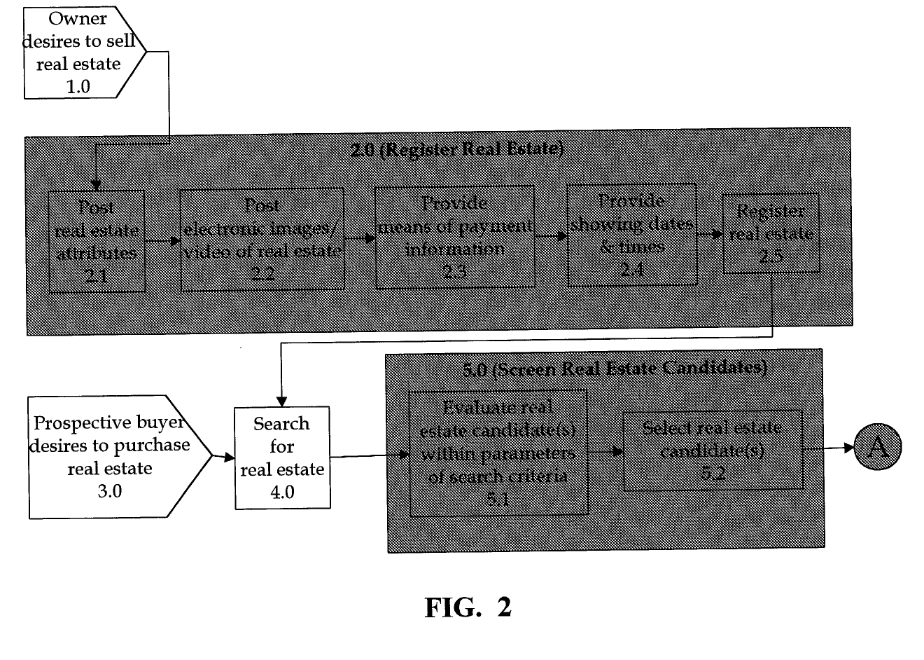

Further, the SSREB application allows the seller and prospective buyer to view the offerings of various providers of complementary services for the sale and purchase of real estate and to link directly to the web pages of said service providers from the seller's and buyer's personal computers via the internet. FIGS. 2 through 4 described below specify the SSREB activities in greater detail.

Reference is now made to FIG. 2 which illustrates SSREB activities as follows:

Owner Desires to Sell Real Estate (Reference Activity 1.0)

This is a condition and is not facilitated or executed by the SSREB application. This condition is the required precursor to all subsequent activities within the SSREB process. The condition is such that the lawful owner of residential and/or commercial real estate has the intent to sell said real estate under certain specified conditions and parameters known by the owner.

Register Real Estate (Reference Activity 2.0)

Given the owner's desire and intent to sell residential and/or commercial real estate, the owner uses the SSREB application to register the real estate for sale.

Post Real Estate and Seller Attributes (Reference Activity 2.1)

In order to register the owner's real estate for sale, the owner accesses the SSREB application from the seller's personal computer via the internet by searching on key phrases and/or the SSREB URL/domain name to launch the SSREB home page. On first use, the seller registers as a SSREB application user by providing a user name and password. On subsequent use, the seller logs into the SSREB application using their user name and password. The seller then creates a record in the SSREB database by posting a minimum of the following attributes to the record:

Related to the property for sale:

Residential or Commercial real estate

Asking price

Full Address

Number and types of rooms

Total square footage

Latest real estate tax bill amount

Latest school tax bill amount

Others TBD

Related to the seller:

Full name

Phone number

Post Electronic Images/Video of Real Estate (Reference Activity 2.2)

Optionally, the owner is able to post digital photos and/or digital video clips of any or all rooms, living space and landscaping in/on the real estate for sale to the real estate record in the SSREB database from the seller's personal computer via the internet. This is accomplished via the SSREB by a browse function allowing the owner to navigate to and attach the digital photos and/or video files to the real estate record. The SSREB will allow for association of the following attributes with each attached digital photo or video file:

Living room 1 and 2

Den 1 and 2

Bedroom 1 through 5

Kitchen

Dining room

Family room 1 and 2

Basement

Game room

Florida Room 1 and 2

Bathroom 1 through 4

Front yard

Back yard

Home front view

Home back view

Home side views 1 and 2

Provide Means of Payment Information (Reference Activity 2.3)

When the owner has posted all mandatory attributes related to the real estate for sale to the SSREB database, the owner is prompted by the SSREB application to provide means of payment information to the subject real estate record from the seller's personal computer via the internet. The SSREB prompts the seller to provide a valid credit card number and expiration date for posting to the real estate record as means of payment should the posting of owner's real estate on the SSREB application result in a consummated sale of the subject real estate.

Provide Showing Dates & Times (Reference Activity 2.4)

The SSREB application enables the owner to post the specific dates and times the real estate for sale will be available for showing to prospective buyers using a calendar utility in the SSREB application. The seller launches the calendar utility by clicking a single icon on the SSREB application interface. The SSREB application presents the seller with a calendar with several functions allowing rapid population of showing time data to the SSREB database. For example, the functions will allow the seller to choose all business days from 9:00 a.m. to 6:00 p.m. for showing or to choose every other Tuesday from 12:00 p.m. to 4:00 p.m. starting on a particular date or all weekend days from 2:00 p.m. to 6:00 p.m. In all cases the seller is prompted by the SSREB application to provide a termination date for showing which is no later than 6 months from the current date. The SSREB enables the seller to update or modify the showing times and showing termination date as frequently as desired via the SSREB application.

Register Real Estate (Reference Activity 2.5)

When the owner has completed all required SSREB application tasks and has provided all required information to the SSREB database as previously outlined, the owner will register their real estate for sale in the SSREB database from the seller's personal computer by pushing a registration button on the SSREB application interface. Prior to completion of registration, the SSREB interface will notify the owner of all legal implications, requirements and conditions associated with offering real estate for sale in the state in which offered. This is accomplished through a query of the SSREB database for said information upon pushing the registration button on the SSREB interface. This same query may be performed by the seller of real estate at any time during the registration process from the seller's personal computer through a query button on the SSREB application interface. The owner may cancel registration when presented with this notification. Registration of real estate for sale in the SSREB application creates the seller and property records in the SSREB database.

Prospective Buyer Desires to Purchase Real Estate (Reference Activity 3.0)

This is a condition and is not facilitated or executed by the SSREB application. This condition is the required precursor to all subsequent activities involving searching, viewing and purchasing real estate within the SSREB process.

Search for Real Estate (Reference Activity 4.0)

In order to search for real estate for sale, the prospective buyer accesses the SSREB via the internet by searching on key phrases and/or the SSREB URL/domain name to launch the SSREB home page. On first use of the SSREB application, the prospective purchaser registers as a SSREB user by providing a user name and password. On subsequent use, the prospective purchaser logs into the SSREB application using their user name and password. After registering or logging in as an SSREB user, the prospective buyer performs a search/query of the SSREB database for properties for sale by specifying values or a range of values for at least one of the following home attributes/search parameters:

Residential or Commercial real estate

Asking price

Zip code and/or city name

County

State

Number and types of rooms

Total square footage

Others TBD

The prospective buyer initiates the SSREB database query from the prospective buyer's personal computer by selecting the values for the desired criteria, then pressing a single icon on the SSREB application page. The SSREB application searches and returns a list of all real estate fitting all search values specified in the query to the prospective buyer. Each property returned from this query is represented on the SSREB application interface by a summary record of data and an icon which, when clicked, enables viewing of all attribute values and digital photo/video files associated with the subject real estate. Additionally, the SSREB application gives the prospective buyer the capability to save discrete sets of search attributes as separate files associated with the prospective buyer's record. This is accomplished through clicking a “save” button on the search/query generation screen. The SSREB application periodically and automatically executes any previously saved set of search attributes to produce matches for the set(s) of attributes against properties listed in the SSREB database in the future. This so called “bot” feature of the SSREB application will conduct the automatic search once daily and notify the prospective buyer of matches via an e-mail message with a link directly to the matching real estate record. This feature is another key differentiator of the SSREB.

Screen Real Estate Candidates (Reference Activity 5.0)

The prospective buyer reviews the returned real estate records as desired. Again, each property returned from the prospective buyer's query is represented on the SSREB application interface by a summary record of data and an icon which, when clicked, enables viewing of all attribute values and digital photo/video files associated with the subject real estate. Each matching record is represented by the values or range of values of the attributes selected by the prospective buyer. For example, if the prospective buyer chose to search for all residential real estate for sale that is in zip code 99999, with at least 2,000 square feet, with no more than 3 bedrooms, and between 1.0 to 1.5 acres of lawn space. the SSREB would return the following fields for all records that meet the following parameters:

Field: Type real estate. Value =“residential”

Field: Zip code. Value=99999

Field: Square footage. Value>2,000

Field: Bedrooms. Value<_{—}3

Field: Lawn space. 1.0<_Value<_{—}1.5

The prospective buyer can then double click on any record to view the full complement of attribute values for that particular record. This includes the following fields and optional digital photo/video files.

Fields

Residential or Commercial real estate

Asking price

Full Address

Number and types of rooms

Total square footage

Latest real estate tax bill amount

Latest school tax bill amount

Others TBD

Photo/Video Files

Living room 1 and 2

Den 1 and 2

Bedroom 1 through 5

Kitchen

Dining room

Family room 1 and 2

Basement

Gameroom

Florida Room 1 and 2

Bathroom 1 through 4

Front yard

Back yard

Front view

Back view

Side view 1 and 2

The prospective buyer can save these real estate records for retrieval at a later time/date by clicking a single “save all” icon on the SSREB interface. Alternatively, the prospective buyer may save individual records by clicking a “save” icon next to each record which the prospective buyer desires to save, then pressing a “save selected records” icon on the SSREB interface.

Evaluate Real Estate Candidate(s) Within Parameters of Search Criteria (Reference Activity 5.1)

The SSREB application allows the prospective buyer to produce and print a 2-dimensional comparison table of all records meeting the prospective buyer's search criteria from the prospective buyer's personal computer. The table is populated with the attribute values of the properties matching the search attribute values or ranges selected by the prospective buyer. The table will be produced by clicking on a single icon. The table will be sent the prospective buyer's printer by clicking a single icon/button.

Select Real Estate Candidate(s) (Reference Activity 5.2)

From the prospective buyer's personal computer, and using the real estate attribute values, digital photo/video files, and comparison table as desired, the prospective buyer may select real estate of interest for viewing. This is an off-line decision making process. To enable this process, the SSREB application provides (as available) various demographic, economic and geographic reports related to the county and/or state in which the subject property exists. The prospective buyer may access these reports from the prospective buyer's personal computer and through the SSREB application by clicking a single icon (one each report icon exists on the SSREB interface for demographic, economic and geographic data). Additionally, the prospective buyer is able to access a list of various service providers and vendors local to the address of the subject property by the clicking a single icon. This embodiment is more fully described in the activity 11.0 description on page 26 of this document.

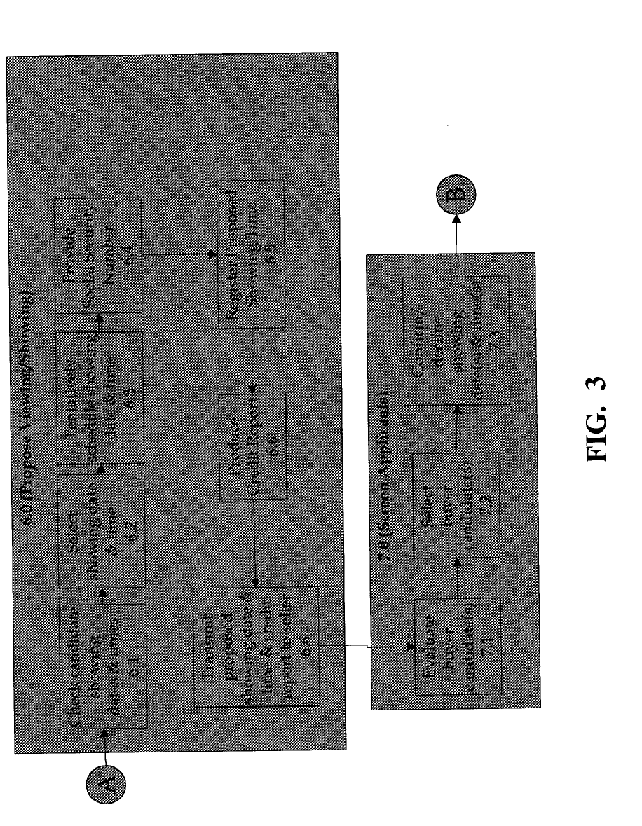

Reference is now made to FIG. 3 which illustrates additional SSREB activities as follows:

Propose Viewing/Showing (Reference Activity 6.0)

The SSREB application enables the prospective buyer to view and select from all available real estate showing times previously populated by the sellers of real estate from the prospective buyer's personal computer.

Check Candidate Showing Dates & Times (Reference Activity 6.1)

For those properties the prospective buyer selects from the SSREB application database, the prospective buyer is able to view a calendar of available showing times by clicking on a single icon next to the real estate summary record or detailed record on the SSREB interface. The icon will launch the calendar function which displays the dates and times of available showing as previously determined by the seller of subject real estate in activity 2.4. The available dates and times are clearly highlighted and specified in text on the calendar. The prospective buyer will be able to view all showing times for the selected property by month and year by populating a “go to month and year” field on the SSREB interface.

Select Showing Date & Time (Reference Activity 6.2)

The prospective buyer selects desired showing times for the real estate of interest. This is a mental process not enabled by the SSREB.

Tentatively Schedule Showing Date & Time (Reference Activity 6.3)

For those properties of interest, the prospective buyer may propose a showing date and time via the SSREB application from the prospective buyer's personal computer. This is accomplished via the calendar utility of the SSREB by clicking on the desired date/time block directly on the SSREB calendar or by populating date/time fields within the SSREB calendar utility.

Provide Social Security Number (Reference Activity 6.4)

For purposes of task 6.6, “Produce Credit Report”, the SSREB application prompts the prospective buyer to optionally input the prospective buyer's social security number and, at the same time, notifies the prospective buyer that the information will be used to produce and provide a credit report(s) for and to the seller(s) of the property(ies) of interest. This is not a mandatory task or mandatory data for continued processing of the proposed showing time(s).

Register Proposed Showing Time (Reference Activity 6.5)

From the prospective buyer's personal computer, the prospective buyer completes submission of selected showing time(s) by clicking a single icon on the SSREB interface. By registration of the proposed showing time(s) the SSREB application creates the buyer record and the prospective sales record in the SSREB database.

Produce Credit Report (Reference Activity 6.6)

If the prospective buyer has elected to provide his/her social security number in activity 6.4, the SSREB application automatically links to of the major credit reporting agencies to send an order for production of a credit report(s) of the prospective buyer. Via automated link (Application Programming Instructions (API)), the SSREB sends an order containing the Social Security Number and name of the prospective buyer to one of three major credit agencies. Via automated link (API), the credit agency information system automatically transmits a credit report(s) of the prospective buyer to the SSREB database. This report(s) is linked to the buyer record and the prospective sales in the SSREB database.

Transmit Proposed Showing Date & Time & Credit Report to Seller (Reference Activity 6.7)

In the case where the prospective buyer has submitted his/her social security number to the SSREB database, and when the prospective buyer's credit report(s) have been received from the credit agency(ies) and posted to the buyer and prospective sales records, the SSREB application automatically transmits an e-mail message to the seller of the subject real estate, notifying the seller that a prospective buyer has proposed a showing time. In the case where the prospective buyer has not submitted his/her social security number to the SSREB database, the SSREB application automatically transmits an e-mail message to the seller of the subject real estate, notifying the seller that a prospective buyer has proposed a showing time.

Screen Applicants (Reference Activity 7.0)

The e-mail defined in activity 6.7 above will contain a URL link to launch the SSREB tool from the seller's personal computer. The seller may log-in to the SSREB application to review the proposed showing time(s) and credit report(s) (if applicable), and to either accept or decline the proposed showing time. The SSREB application will present the seller with an icon that when double clicked, will present the seller with the data from the prospective sale record. This information includes the proposed showing time and the prospective buyer's credit report(s) (if applicable) from the SSREB database. The credit reports presented to the seller will not contain the name and the Social Security Number of the prospective buyer.

Evaluate Buyer Candidate(s) (Reference Activity 7.1)

Upon e-mail notification of the proposed showing time(s) or as desired by the seller, and from the seller's personal computer, the seller is able to review all proposed showing time(s) and, as applicable, the credit report(s) of each prospective buyer who proposed a showing time(s) for the subject real estate. The seller may access the SSREB for examination of the schedule and/or credit information either through the e-mail link to the SSREB application and database (defined in activity 6.7), or through normal SSREB log-in procedures. Each prospective buyer will be reported to the seller with the proposed showing time and credit report(s) as applicable.

Select Buyer Candidate(s) (Reference Activity 7.2)

Using the proposed showing time(s) and the credit report(s) as desired, the seller selects the prospective buyer(s) to whom to show the subject real estate. This is an off-line decision making process not enabled by the SSREB, however, the SSREB will provide guidelines on demand to the seller which will assist the seller to interpret and evaluate the prospective buyers' credit report(s). These guidelines are available to the seller from the seller's personal computer and from the SSREB application and database at the click of a single icon on the SSREB interface.

Confirm/Decline Showing Date(s) & Time(s) (Reference Activity 7.3)

From the seller's personal computer, and via the calendar function of the SSREB application, the seller is able to accept or decline the showing time(s) proposed by the prospective buyer(s) or to propose an alternate showing time(s). As desired, the seller is able to provide notes and comments to be transmitted to the prospective buyer(s) to which the seller is responding.

If the proposed showing time is acceptable to the seller, the seller accepts the appointment by clicking a single icon on the SSREB interface. This action by the seller updates the prospective sale record with the scheduled appointment for showing of the subject real estate. The prospective buyer is notified via automated e-mail that the showing time is accepted and confirmed by the seller. Any comments provided by the seller are included in the e-mail message.

If the proposed showing time is not acceptable to the seller, the seller declines the appointment by clicking a single icon on the SSREB interface. The prospective buyer is notified via automated e-mail that the showing time is declined by the seller. Any comments provided by the seller are included in the e-mail message. In this eventuality, the process ends for that particular seller and buyer pair.

If the seller wishes to propose an alternate showing time(s), the seller may do so by selecting an alternative time-slot(s) and clicking a single icon. Additionally, the seller may provide comments to the prospective buyer. The seller's proposed alternative showing time(s) and comments (as applicable) are sent to the prospective sale record and are transmitted to the prospective buyer via automated e-mail. Upon notification of an alternative showing time(s) made by the seller to the prospective buyer, the prospective buyer may accept the alternative showing time(s) via a single click in the calendar function of the SSREB. The calendar function will be made available to the prospective buyer through automated link from the e-mail sent from the seller or through normal SSREB log-on procedures. If the prospective buyer does not accept the alternate showing time by the time of the proposed alternate showing, the process ends for that particular seller and buyer pair.

If the seller accepts the proposed showing time(s) made by the prospective buyer or the prospective buyer accepts the alternative showing time(s) proposed by the seller, the SSREB application will update the prospective sale record with the scheduled showing time(s) and will automatically transmit the following:

To the e-mail account of the prospective buyer:

Full address of the subject real estate

Full name of the seller

Phone number of the seller

Confirmed date and time(s) of showing

To the e-mail account of the seller:

Full name of the prospective buyer

Phone number of the prospective buyer

Confirmed date and time(s) of showing

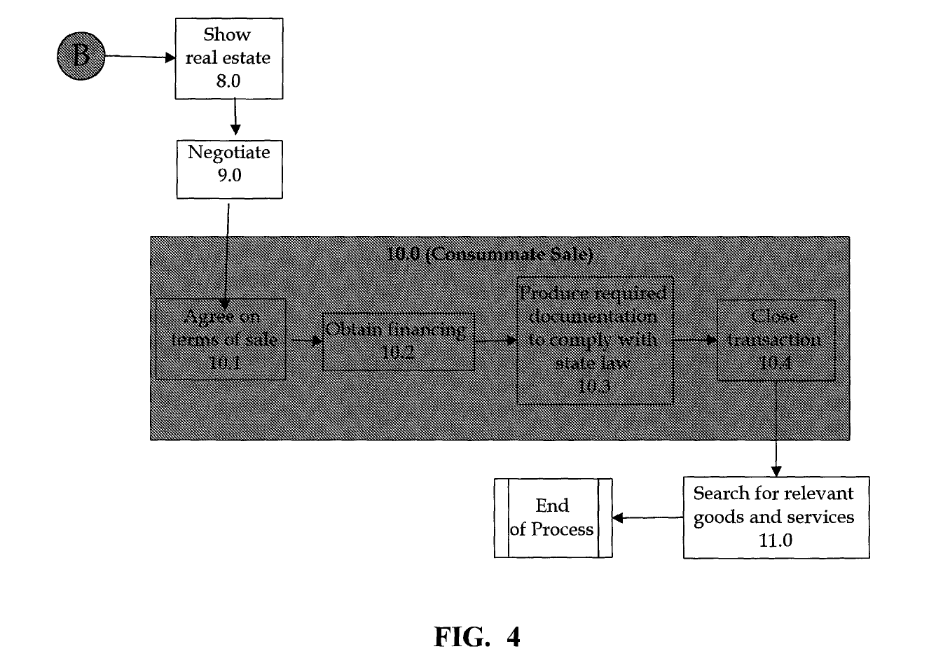

Reference is now made to FIG. 4 which illustrates the balance of SSREB activities as follows:

Show Real Estate (Reference Activity 8.0)

The seller and buyer participate in the showing of the subject real estate. This is a manual process not enabled by the SSREB.

Negotiate (Reference Activity 9.0)

The seller and buyer negotiate mutually agreeable terms of sale for the subject real estate. The SSREB is a knowledge management system which may assist the seller and prospective buyer to effectively negotiate the terms of sale. On demand, The SSREB application and database will provide to both the seller and the buyer general instructions on negotiating methods and techniques. Additionally, the SSREB application will provide real estate sales and purchasing guidelines and checklists from commercially available software programs (real estate specific) to both sellers and buyers on demand. Said programs will be accessible and searchable via icons on the subject system's interface at all times from both the seller's and prospective buyer's personal computer.

Consummate Sale (Reference Activity 10.0)

Once the seller and prospective buyer have negotiated mutually agreeable terms of sale, the SSREB enables effective consummation of the sale. The SSREB is a knowledge management system which will enables the seller and prospective buyer to effectively consummate the sale according to the laws of the state in which the property exists. On demand, The SSREB application and database will provide to both the seller and the buyer specific instructions and guidelines for sale of real estate in the state in which the real estate exists. This includes presentation of all relevant laws governing the sale of real estate in the subject locality.

Agree on Terms of Sale (Reference Activity 10.1)

From the seller's and prospective buyer's personal computer and via the SSREB application and database., the seller and the prospective buyer are able to access all relevant state law related to the sale of residential or commercial real estate (as appropriate) and to access and print all documentation and forms required for the legal sale of real estate by law in the state in which the property exists. Further, the tool will provide instructions for completing and properly registering/recording all required forms and documentation. This information may be used by the seller and prospective buyer to come to mutually agreeable terms of sale. The seller and/or prospective buyer may access this information for any state at any point in this process.

Obtain Financing (Reference Activity 10.2)

The SSREB application will assist the prospective buyer to obtain financing for the purchase of the subject real estate. Via the SSREB, the prospective buyer may be linked directly to one or more on-line mortgage brokerage services. This linkage may be integral to the SSREB via an Application Programming Instruction (API) to the mortgage lender service application, or may merely launch the mortgage lender service(s) web page(s) via a URL imbedded in the SSREB. The SSREB application remains active on the prospective buyer's personal computer while the prospective buyer is engaged in mortgage lending service activities. In this way, the prospective buyer is able to return to the SSREB application and database once complete with said activities.

Produce Required Documentation to Comply with State Law (Reference Activity 10.3)

Assuming financing is obtained, or a cash transaction is agreed to, the seller and/or buyer access, print and complete all required documentation for legal sale in the state in which the subject real estate exists from their personal computers via the SSREB application. The SSREB application has a utility which enables both seller and buyer to access all relevant federal and state law related to the sale of residential or commercial real estate (as appropriate) from the SSREB database and to access and print all documentation and forms required by law in the state in which the property exists from the seller's and buyer's personal computer. Further, the SSREB application provides from its database all instructions for completing and properly registering/recording all required forms and documentation. The relevant laws, forms, documentation and instructions are available to both the buyers and sellers of real estate on demand from the buyer's and seller's personal computer at any point in the SSREB process.

Further, the SSREB application allows the seller to put the subject real estate in a “pending sale” status and, at the same time, provide the scheduled closing date from the seller's personal computer. This information is posted to the sale record in the SSREB database. When in a “pending sale” status, the subject real estate will continue to be listed on the SSREB application, but highlighted with an icon and text indicating the subject real estate is in a “pending sale” status. While in a “pending sale” status, prospective buyers and/or sellers may not schedule showing time(s)/alternate showing time(s) for the subject real estate or perform any other functions related to showing, negotiation and closing of sale for the subject real estate with any other than the existing brokered seller-buyer pair. When a “pending sale” status is posted to the sale record in the SSREB database, the SSREB application will send an automatic e-mail message to both seller and buyer to recommend the engagement of a real estate attorney for both the seller and the buyer for the purpose of reviewing all completed documentation and to be present at the closing event to ensure the sale is legal and binding in the state in which the property exists.

Close Transaction (Reference Activity 10.4)

The closing of the sale of the real estate is a manual process not enabled by the SSREB application. However, the SSREB application will, on demand, provide the seller or prospective buyer with guidelines on how to conduct a real estate sale closure. This information is available to the SSREB users from the users' personal computer at any time during the SSREB process via clicking a single icon.

Subsequent to the sale closing, the SSREB application allows the seller to transmit the closing date, sale price and buyer name to the subject real estate record to the SSREB database from the seller's personal computer via the SSREB application. Based on this information, the SSREB application removes the subject real estate record from the active list of real estate for sale and archives the seller, the buyer, and the prospective sale records. On the fifth working day after the scheduled closing, if the closing data is not provided to the SSREB application, the seller will be prompted by an automatic e-mail message sent by the SSREB application to access and update the subject real estate record with either:

the actual closing date

the rescheduled closing date, or

re-activation of the subject real estate record by removal of the “pending sale” status.

In case of re-activation of the subject real estate record by the seller, or no response from the seller to the aforementioned e-mail within 14 working days, or if the seller does not within 60 working days of a scheduled showing time, post a pending sale status or scheduled closing date, the SSREB will automatically link to the relevant state and/or federal real estate database(s) to verify the subject real estate has not been sold. If the subject real estate had been sold within the previous six months, the SSREB application automatically posts notification of sale, sale price and name of purchaser to the subject real estate record.

Further, the SSREB application provides for debiting the credit card account of the seller of the subject real estate when sale of the subject property to a SSREB brokered buyer is verified by the seller or by the relevant state and/or federal real estate database(s).

Search for Relevant Goods and Services (Reference Activity 11.0)

The SSREB application will have URL links to various providers of services and goods which may be helpful to the prospective buyer and/or seller during the course of the SSREB process and subsequent to the process. The links to providers of services and goods may be accessed by the prospective buyer and the seller at any time during the process. Via the SSREB application, the prospective buyer and seller may be linked directly to the following services. Note that the following list is illustrative and is not all inclusive or exhaustive of links to service and goods providers:

Title insurance sales (national providers)

Home insurance sales (national providers)

Auto insurance sales (national providers)

Mortgage lenders (national providers)

Banks (national providers)

Home/commercial moving companies (national providers)

Home appraisers (local providers; based on zip code of subject real estate)

Home inspectors

Real Estate attorneys

General contractors (local providers; based on zip code of subject real estate)

Interior/exterior decorators (local providers; based on zip code of subject real estate)

Landscapers (local providers; based on zip code of subject real estate)

School districts (local providers; based on zip code of subject real estate)

Government departments and agencies (local providers; based on zip code of subject real estate)

State, county and city and locality home pages (local providers; based on zip code of subject real estate)

Hospitals (local providers; based on zip code of subject real estate)

These linkages may be integral to the SSREB application, or may merely launch the home page of the providers of services and goods via a URL imbedded in the SSREB interface.

Employing the full breadth and depth of the SSREB application and database capability will provide significant value to the sellers and buyers of single family homes and is the differentiating factor between the SSREB and other existing real estate web sites which utilize the services of traditional real estate brokers.

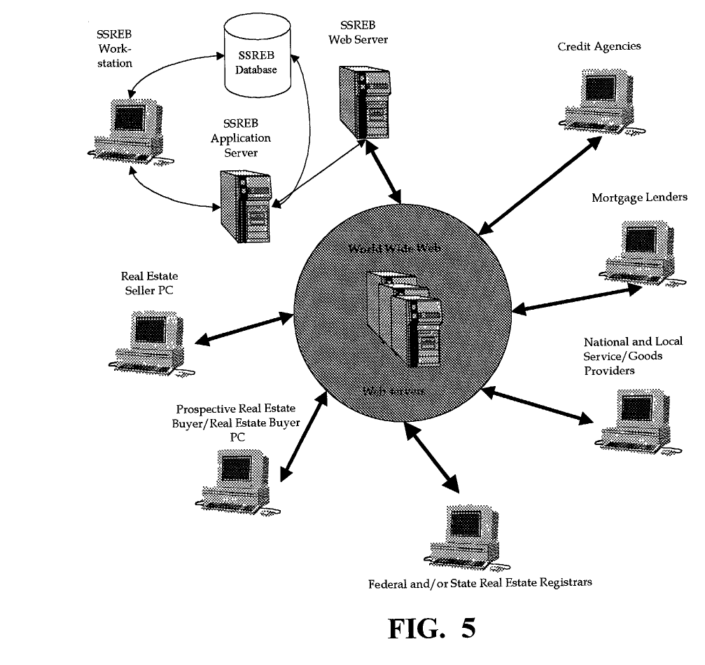

Referring now to FIG. 5, the technical architecture of the subject self-service real estate brokerage system will be discussed. Generally, the SSREB technical architecture matches and then connects prospective buyers and sellers of real estate via the internet. The match allows the prospective buyer to search and find real estate records formerly posted by the seller on the SSREB. The connection allows for revealing of the identity of the seller to the buyer and the buyer to the seller in order for the pair to negotiate and consummate the sale of said real estate. Additionally, the architecture enables both sellers and prospective buyers to access and communicate with third party service and goods providers which are complementary to the marketing and sale of real estate as well as to mortgage lenders, credit agencies and federal/state/local real estate registrars in order to perform specified tasks in the SSREB process.

The seller and prospective buyer are connected through the internet via the SSREB database which creates and updates records containing key data and milestones of the SSREB process. These data and milestones include matching of prospective buyer search criteria and home listing characteristics, scheduled property showing, scheduled closing date, revised scheduled closing date, actual closing date, sale price and name of purchaser.

Further, the SSREB has internet or intranet links with various federal, state and local real estate registrar databases which enable the SSREB host to research and/or verify the sale of subject real estate, and to provide the sellers and buyers of real estate relevant statistics regarding real estate markets within the 48 contiguous United States.

The physical components of the system include novel software providing two unique interfaces; one for sellers and one for buyers, a host system; a plurality of remote data terminals and processors; processing means within said host system including a central processing unit and associated memory means; data transmission means providing a signal path for data exchange between said host system and the plurality of data terminals and processors; communication means associated with the host system, the communications means being controlled by the processing means to provide and receive data transmissions between the host system and the remote terminals; data storage means within the host system, the data storage means maintaining a plurality of data records and files of different types including property records, seller records, buyer records, prospective sales records and sales records; means for allowing the central host computer to obtain credit history data pertaining to said prospective buyers from remote credit information servers and communicating the credit history data to the sellers all via the internet; means for permitting sellers and prospective buyers to schedule showings of real estate and to negotiate the terms of sale of the property all via the internet; means for providing sellers and prospective buyers via the internet all documentation necessary to consummate the sale of real estate; means for verifying with federal, state and/or local registries via the internet the sale of said real estate; and means for paying the operator of said central host computer via the internet for use of the subject self-service real estate brokerage system.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A method of conducting on-line real estate brokerage services over the internet, the method comprising the steps of:
a) receiving on a host computer property listings from remote personal computers via the internet; said property listings including descriptive indicia, price, digital photographs and/or streaming video, all relating to each property for sale;
b) storing said property listings in a searchable database on said host computer;
c) allowing prospective buyers to search for and display on their remote personal computers any or all of said property listings via the internet;
d) receiving on said host computer from said remote personal computers information and authorizations necessary to procure credit histories of said prospective buyers;
e) receiving on said host computer said credit histories of said prospective buyers from remote computers of outside credit information providers via the internet;
f) transmitting said credit history from said host computer to said remote personal computers of said sellers via the internet or alternatively allowing said remote personal computers to access said information on said host computer;
g) permitting said prospective buyers and said sellers to schedule showing dates and times on said host computer via the internet;
h) permitting said prospective buyers and said sellers to negotiate the terms of sale of the listed properties through said host computer via the internet;
i) receiving on said host computer from said remote personal computer of said prospective buyers and said sellers data for the completion of all required real estate sales documentation;
j) preparing and transmitting to said prospective buyers and said sellers all required real estate sales documentation for signature;
k) verifying the sale of said listed properties with federal, state and/or local registries; and
l) providing for payment of host computer usage fees via the internet from buyers and sellers who have consummated a sale.

2. A remote self-service real estate brokerage system on the internet comprising:
a) means for allowing sellers of real estate to provide property listing information on a central host computer via the internet;
b) means for allowing prospective buyers of real estate to access and retrieve said property listing information via the internet;
c) means for allowing said central host computer to obtain credit history data pertaining to said prospective buyers from remote credit information servers and communicating said credit history data to said sellers all via the internet;
d) means for permitting said sellers and said prospective buyers to schedule showings of said real estate and to negotiate the terms of sale of said real estate all via the internet;
e) means for providing said sellers and said prospective buyers via the internet all documentation necessary to consummate the sale of said real estate;
f) means for verifying with federal, state and/or local registries via the internet the sale of said real estate; and
g) means for paying the operator of said central host computer via the internet for use of the subject self-service real estate brokerage system.

3. A remote self-service real estate brokerage system on the internet comprising:
a) a host system;
b) a plurality of remote data terminals and processors;
c) processing means within said host system including a central processing unit and associated memory means;
d) data transmission means providing a signal path for data exchange between said host system and said plurality of data terminals and processors;
e) communications means associated with said host system, said communications means being controlled by said processing means to provide and receive data transmissions between said host system and said remote terminals;
f) data storage means within said host system, said data storage means maintaining a plurality of data records and files of different types including property records, seller records, buyer records, prospective sales records and sales records;
g) means for allowing said central host computer to obtain credit history data pertaining to said prospective buyers from remote credit information servers and communicating said credit history data to said sellers all via the internet;
h) means for permitting said sellers and said prospective buyers to schedule showings of said real estate and to negotiate the terms of sale of said real estate all via the internet;
i) means for providing said sellers and said prospective buyers via the internet all documentation necessary to consummate the sale of said real estate;
j) means for verifying with federal, state and/or local registries via the internet the sale of said real estate; and
k) means for paying the operator of said central host computer via the internet for use of the subject self-service real estate brokerage system.
